(19) United States
(12) Patent Application Publication
(10) Pub. No.: US 2013/0162865 A1
(43) Pub. Date: Jun. 27, 2013

(54) IMAGING DEVICE

(71) Applicant: PANASONIC CORPORATION, Osaka (JP)

(72) Inventor: MITSUO ABE, Osaka (JP)

(73) Assignee: PANASONIC CORPORATION, Osaka (JP)

(21) Appl. No.: 13/705,302

(22) Filed: Dec. 5, 2012

(30) Foreign Application Priority Data
Dec. 22, 2011 (JP) 2011-280941
Aug. 10, 2012 (JP) 2012-178118

(51) Int. Cl. H04N 5/232

(52) U.S. Cl. CPC H04N 5/23229
USPC 348/231.3

(57) ABSTRACT

The imaging device includes an imaging component, an image recorder, an altitude recorder, and a display controller. The imaging component captures an image of a subject, produces image data at a first time and outputs the image data. The image recorder associates the first time with the image data and records the first time associated with the image data. The altitude recorder periodically acquires information related to an altitude. The altitude recorder also associates a second time with the information related to the altitude. The altitude recorder also records changes in the information related to altitude occurring by the second time, as altitude history information. The display controller displays the altitude history information recorded by the altitude recorder, and information indicating the first time.

### CROSS-REFERENCE TO RELATED APPLICATIONS

This application claims priority under 35 U.S.C. §119 to Japanese Patent Application No. 2011-280941, filed on Dec. 22, 2011 and No. 2012-178118, filed on Aug. 10, 2012. The entire disclosure of Japanese Patent Application No. 2011-280941 and No. 2012-178118 are hereby incorporated herein by reference.

### BACKGROUND

1. Technical Field

The technology disclosed herein relates to an imaging device and an image reproduction device.

2. Background Information

A conventional imaging device, such as a digital camera capable of capturing and recording images of a subject, has a configuration such that information about the altitude at the time of imaging can be provided to the captured image data and recorded (see Japanese Laid-Open Patent Application 2011-49948, for example).

A conventional digital camera comprises an altitude measurement means for measuring altitude. With this digital camera, the altitude measured by this altitude measurement means is added to the image data as additional information. Consequently, with this digital camera the image data can be searched or sorted by altitude.

Greater convenience is to be desired with such conventional digital cameras.

This disclosure was conceived in light of the above problems, and it is an object thereof to provide an imaging device that is more convenient to use.

### SUMMARY

A imaging device disclosed herein comprises an imaging component, an image recorder, an altitude recorder, and a display controller. The imaging component is configured to capture an image of a subject, produce image data at a first time and output the image data. The image recorder is configured to associate the first time with the image data and record the first time associated with the image data. The altitude recorder is configured to periodically acquire information related to an altitude. The altitude recorder is configured to associate a second time with the information related to the altitude. The altitude recorder is configured to record changes in the information related to altitude corresponding to an elapse of the second time, as altitude history information. The information related to altitude is acquired at the second time. The display controller is configured to display the altitude history information recorded by the altitude recorder, and information indicating the first time.

This technology makes it possible to provide an imaging device that is more convenient to use.

### BRIEF DESCRIPTION OF THE DRAWINGS

Referring now to the attached drawings, which form a part of this original disclosure:

FIG. 1 is a diagram of the configuration of the front face of a digital camera 100 pertaining to Embodiment 1;

FIG. 2 is a diagram of the configuration of the rear face of the digital camera 100 pertaining to Embodiment 1;

FIG. 3 is a diagram of the electrical configuration of the digital camera 100 pertaining to Embodiment 1;

FIG. 4 is a flowchart of the processing in imaging mode in Embodiment 1;

FIG. 5 is a flowchart of processing to capture a still picture in Embodiment 1;

FIG. 6 is a flowchart of the processing in reproduction mode in Embodiment 1;

FIG. 7 shows an example of the screen display in reproduction mode in Embodiment 1; and

FIG. 8 is a diagram of the electrical configuration of the digital camera 100 in another embodiment.

### DETAILED DESCRIPTION OF EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### Embodiment

The digital camera 100 in Embodiment 1 is able to acquire the position of the digital camera 100. The digital camera 100 produces map image data by acquiring map data, including the imaging position, from a map database during the capture of a still picture. The digital camera 100 records still picture image data and map image data in a single file. The configuration and operation of the digital camera 100 will now be described.

### 1. Configuration

The configuration of the digital camera 100 will now be described through reference to the drawings.

### 1-1. Configuration of Digital Camera

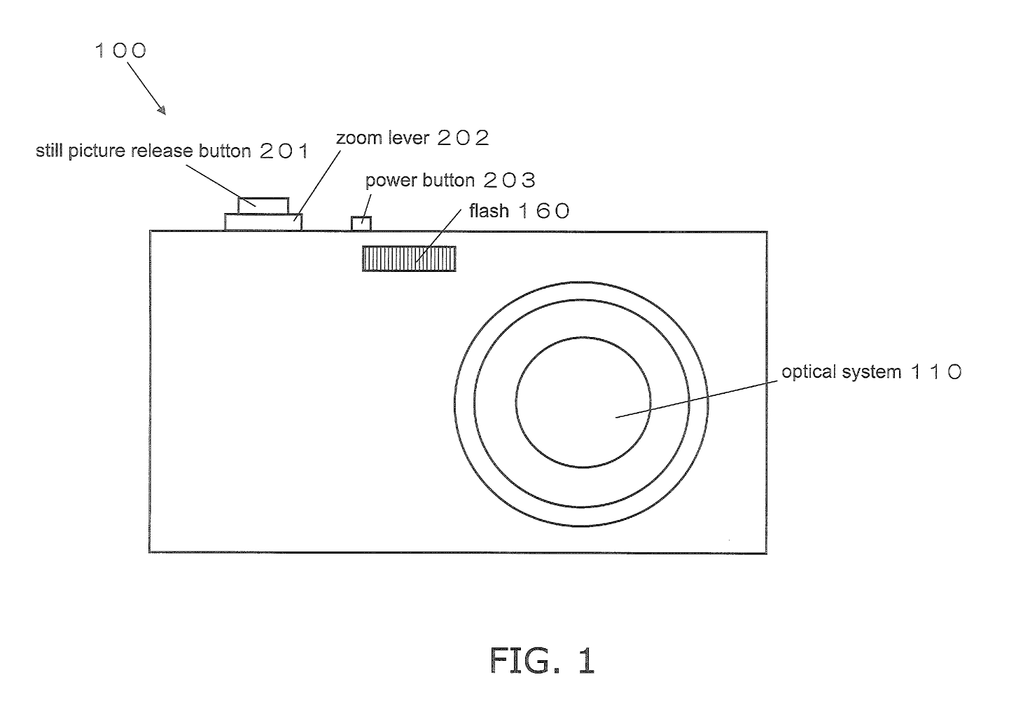

FIG. 1 is a diagram of the configuration of the front face of the digital camera 100. The digital camera 100 comprises on its front face a lens barrel that holds an optical system 110, and a flash 160. The digital camera 100 also comprises control buttons on its top face. These control buttons include a still picture release button 201, a zoom lever 202, a power button 203, and so forth.

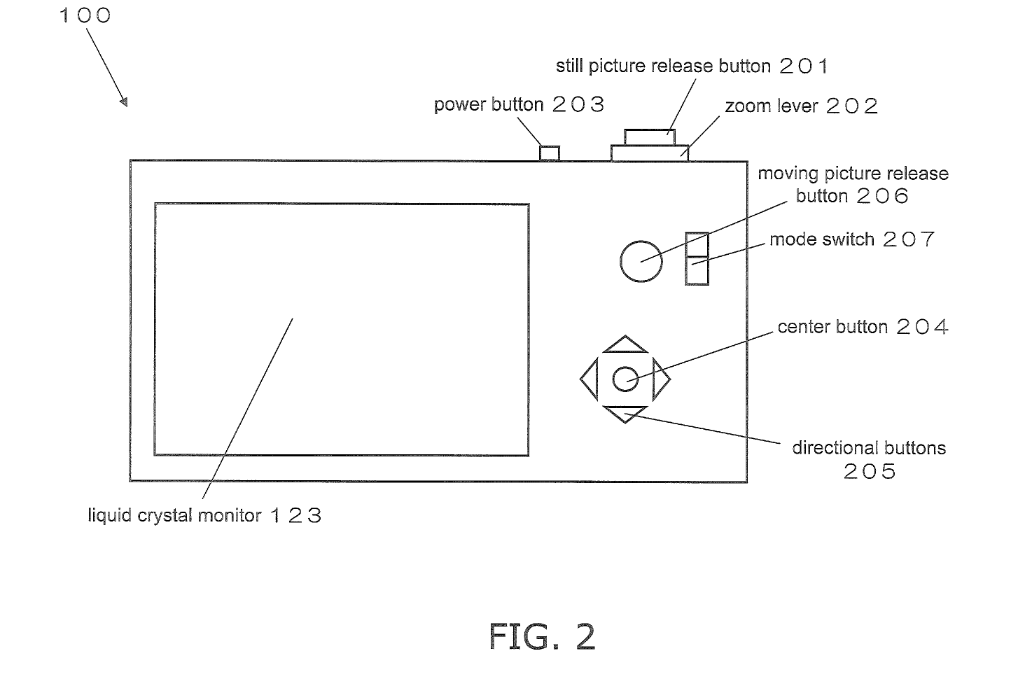

FIG. 2 is a diagram of the configuration of the rear face of the digital camera 100. The digital camera 100 comprises control buttons on its rear face. These control buttons include a liquid crystal monitor 123, a center button 204, directional buttons 205, a moving picture release button 206, a mode switch 207, and so forth.

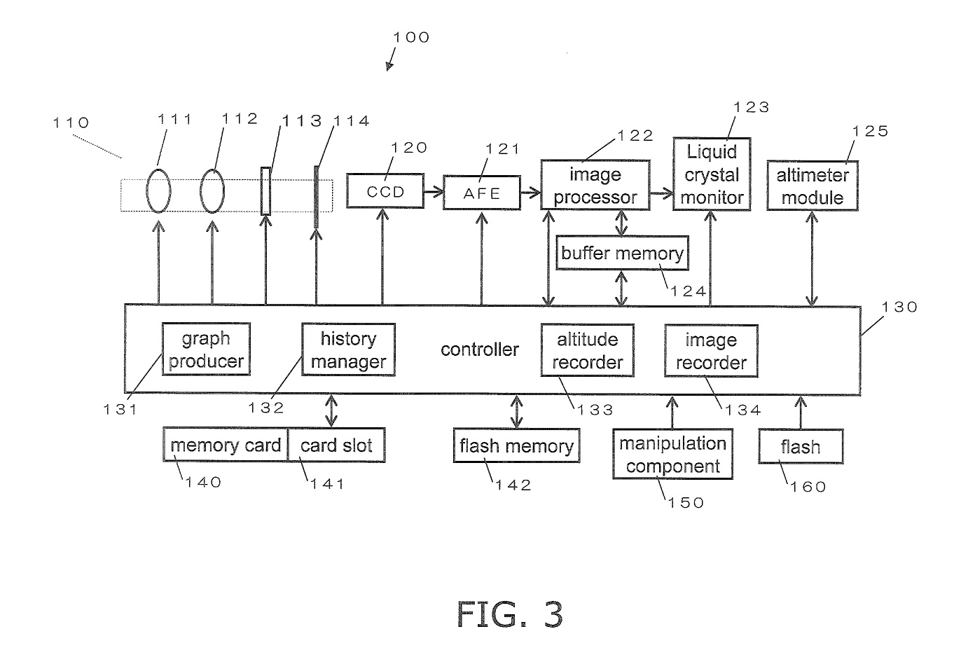

FIG. 3 is a diagram of the electrical configuration of the digital camera 100. The digital camera 100 uses a CCD image sensor 120 to capture a subject image formed through the optical system 110. The CCD image sensor 120 produces image data on the basis of the captured subject image. The image data thus produced undergoes various kinds of processing by an APE (analog front end) 121 and an image processor 122. The image data thus produced is recorded to a recording medium. This recording medium can be a flash memory 142, a memory card 140, or the like. In this embodiment, an example will be described in which the recording medium is the memory card 140.

The image data recorded to the memory card 140 is displayed on the liquid crystal monitor 123 on the basis of the operation of a manipulation component 150 (an example of a selector) by the user. The various components shown in FIGS. 1 to 3 will now be described in detail.

The optical system 110 is made up of a focus lens 111, a zoom lens 112, an aperture 113, a shutter 114, and so forth. Although not depicted, the optical system 110 may include an optical shake correcting lens (OIS: optical image stabilizer). Also, the lenses that make up the optical system 110 may each be constituted by any number of lenses, or may be constituted by any number of groups.

The focus lens 111 is used to adjust the focal state of the subject. The zoom lens 112 is used to adjust the angle of field of the subject. The aperture 113 is used to adjust the amount of light incident on the CCD image sensor 120. The shutter 114 is used to adjust the exposure time with incident light on the CCD image sensor 120. The focus lens 111, the zoom lens 112, the aperture 113, and the shutter 114 are each driven by a corresponding drive means such as a DC motor or a stepping motor, according to a control signal issued by a controller 130.

The CCD image sensor 120 produces image data by capturing a subject image formed through the optical system 110. The CCD image sensor 120 can produce a new frame of image data at specific intervals when the digital camera 100 is in imaging mode.

The AFE 121 subjects the image data read from the CCD image sensor 120 to noise suppression by correlated double sampling, amplification to the input range width of an A/D converter by analog gain controller, and A/D conversion by A/D converter. After this, the AFE 121 outputs the image data to the image processor 122.

The image processor 122 subjects the image data outputted from the APE 121 to various kinds of processing. These various kinds of processing include smear correction, white balance correction, gamma correction, YC conversion processing, electronic zoom processing, compression processing, reduction processing, expansion processing, and so on. The various kinds of processing are not limited to these. The image processor 122 stores the image information that has undergone the various processing in a buffer memory 124. The image processor 122 may be a hard-wired electronic circuit, or may be a microprocessor that executes programs, etc. The image processor 122 may also be constituted as a single semiconductor chip along with the controller 130 and so forth.

The liquid crystal monitor 123 is provided on the rear face of the digital camera 100. The liquid crystal monitor 123 displays images on the basis of image data processed by the image processor 122. The images displayed by the liquid crystal monitor 123 include through-images and recorded images. Through-images are images in which new frames of image data produced at specific time intervals by the CCD image sensor 120 are continuously displayed. Usually, when the digital camera 100 is in imaging mode, the image processor 122 produces a through-image on the basis of the image data produced by the CCD image sensor 120. The user can capture an image while checking the subject composition by referring to the through-image displayed on the liquid crystal monitor 123.

Recorded images are images in which image data of high resolution recorded to the memory card 140 are reduced to low resolution for display on the liquid crystal monitor 123, when the digital camera 100 is in reproduction mode. The high-resolution image data recorded to the memory card 140 is produced by the image processor 122 on the basis of the image data produced by the CCD image sensor 120 after the user has operated the release button.

An altimeter module 125 acquires air pressure information, and calculates the altitude of the digital camera 100 on the basis of a specific formula. The altimeter module calculates the altitude value and sends a notification of altitude calculation to the controller 130. Upon receiving this notification, the controller 130 acquires the altitude value (the calculation result) from the altimeter module 125 and stores it in the buffer memory 124. In this embodiment, the transition in altitude values in a time series (hereinafter referred to as an altitude history log) is recorded by recording the acquired altitude values at specific time intervals. Therefore, even when the power button 203 is off, the digital camera 100 always performs calculation of altitude values and recording to the altitude history log.

The controller 130 performs overall control over the entire digital camera 100. The controller 130 also records image data stored in the buffer memory 124 to the memory card 140 after processing by the image processor 122. The controller 130 is made up of a ROM for storing programs, a CPU for processing various kinds of information by executing programs, and so forth. In the ROM are stored programs related to file control, auto focus control (AF control), automatic exposure control (AE control), and light emission control over the flash 160. The ROM also stores programs for the overall control of the operation of the entire digital camera 100.

The controller 130 operates as an image recorder 134, an altitude recorder 133, a history manager 132, and a graph producer 131 (an example of a display controller) by executing programs. The altitude recorder 133 acquires altitude values from the altimeter module 125 and records them as an altitude history log to the memory card 140. The history manager 132 manages the bundling of images captured during altitude history log acquisition and management of the altitude history log. The graph producer 131 produces data in the form of a graph to display altitude history log files on the liquid crystal monitor 123.

More precisely, the image recorder 134 records the time at which image data was captured by associating it with the image data. More specifically, the time at which the CCD image sensor 120 produced image data is recorded by user operation, such that it is associated with this image data.

The altitude recorder 133 acquires altitude values from the altimeter module. The altitude recorder 133 also records the acquired altitude values as an altitude history log at specific time intervals. The altitude recorder 133 also operates while the user is switching off the digital camera, and records the altitude history log. The log acquisition start and end are set by user operation for the altitude history log so that a log can be acquired only when intended by the user. The altitude recorder 133 produces a single altitude history log from the transition in altitude values acquired between the start of log acquisition and the end of log acquisition. Therefore, there are a plurality of altitude history logs in the digital camera 100.

The history manager 132 acquires only the image data captured within the period of acquiring the altitude history log, as recorded on the memory card 140. The history manager 132 manages in the altitude history log the times at which each set of image data was captured. There will be a plurality of altitude history logs in the digital camera 100. Therefore, to specify the altitude history log to which the captured image data corresponds, the history manager 132 assigns a specific ID (an example of identification data; hereinafter referred to as altitude history log ID) for each altitude history log file, and manages these IDs. Assigning an altitude history log ID to each set of captured image data allows the user to ascertain the relation between image data and altitude history logs. The “time” referred to here is information that includes the date.

The graph producer 131 uses data in the form of a graph to produce an altitude history displayed on the liquid crystal monitor 123 on the basis of the relation between captured image data and the altitude values in the altitude history log obtained by the history manager 132 (this will be discussed in detail below).

The controller 130 may be constituted by a hard-wired electronic circuit, or by a microprocessor or the like. Also, it may be constituted by a single semiconductor chip along with the image processor 122 and so forth. The ROM need not be an internal component of the controller 130, and may instead be provided externally of the controller 130.

The buffer memory 124 is a storage means functioning as a working memory for the controller 130 or the image processor 122. The buffer memory 124 can be a DRAM (dynamic random access memory) or the like. The flash memory 142 functions as an internal memory for recording image data and setting information, etc., for the digital camera 100.

A card slot 141 is a connection means that allows the memory card 140 to be inserted and removed. The card slot 141 allows the memory card 140 to be electrically and mechanically connected. The card slot 141 may also have the function of controlling the memory card 140.

The memory card 140 is an external memory comprising a flash memory or another such recording component. The memory card 140 records image data processed by the image processor 122, altitude history logs, and other such data.

The manipulation component 150 is a collective name for the control buttons and dials provided to the outer case of the digital camera 100, and is operated by the user. The manipulation component 150 includes, for example, the still picture release button 201, the moving picture release button 206, the zoom lever 202, the power button 203, a center button 204, the directional buttons 205, the mode switch 207, and so forth shown in FIGS. 1 and 2. When operated by the user, the manipulation component 150 sends various operational command signals to the controller 130.

The still picture release button 201 is a two-stage push button that can be pushed halfway down or all the way down. When the user pushes the still picture release button 201 halfway down, the controller 130 executes AF (auto focus) control or (AE auto exposure) control and decides on the imaging conditions. When the user then presses the still picture release button 201 all the way down, the controller 130 records the image data captured at the moment when the button was pushed all the way down, as a still picture to the memory card 140, etc. Unless otherwise specified below, the phrase “the still picture release button 201 is pressed” shall correspond to “is pushed all the way down.”

The moving picture release button 206 is a push button for starting or stopping moving picture recording. When the moving picture release button 206 is pressed by the user, the controller 130 successively records the image data produced by the image processor 122 on the basis of the image data produced by the CCD image sensor 120, as a moving picture to the memory card 140 or other recording medium. When the moving picture release button 206 is pressed again, the recording of the moving picture ends.

The zoom lever 202 is type of lever that automatically returns to the center position, and is used to adjust the field angle between the wide angle end and the telephoto end. When operated by the user, the zoom lever 202 sends the controller 130 an operational command signal for driving the zoom lens 112. Specifically, when the zoom lever 202 is operated to the wide angle end side, the controller 130 drives the zoom lens 112 so that the subject is captured at a wide angle. Similarly, when the zoom lever 202 is operated to the telephoto end side, the controller 130 drives the zoom lens 112 so that the subject is captured at telephoto.

The power button 203 is a push button used by the user to switch the power on and off to the various components constituting the digital camera 100. When the power button 203 is pressed by the user while the power is off, the controller 130 supplies power to the various components constituting the digital camera 100, and actuates them. When the power button 203 is pressed by the user while the power is on, the controller 130 stops the supply of power to the various components. Even when the power is off, however, the digital camera 100 is actuated at a specific timing to record altitude, and the altitude recorder 133 produces an altitude history log.

The center button 204 is a push button. When the user presses the center button 204 while the digital camera 100 is in imaging mode or reproduction mode, the controller 130 displays a menu screen on the liquid crystal monitor 123. The menu screen is used to set the various conditions for imaging and reproduction. The information that is set on the menu screen is recorded to the flash memory 142. When the center button 204 is pressed while a setting category for one of the various conditions has been selected, the center button 204 functions as an enter button.

The directional buttons 205 are push buttons provided in the up, down, left, and right directions. The user presses the directional buttons 205 in one of these directions to select one of the various condition categories displayed on the liquid crystal monitor 123.

The mode switch 207 is a push button provided in the up and down directions. The user presses the mode switch 207 in one of these directions to switch the state of the digital camera 100 between imaging mode and reproduction mode.

The CCD image sensor 120 is an example of an imaging component. The altimeter module 125 is an example of an altitude information acquisition component. The history manager 132 and the graph producer 131 are examples of a display controller. The controller 130 is an example of an image recorder.

### 2. Operation

### 2-1. Imaging Operation of Digital Camera

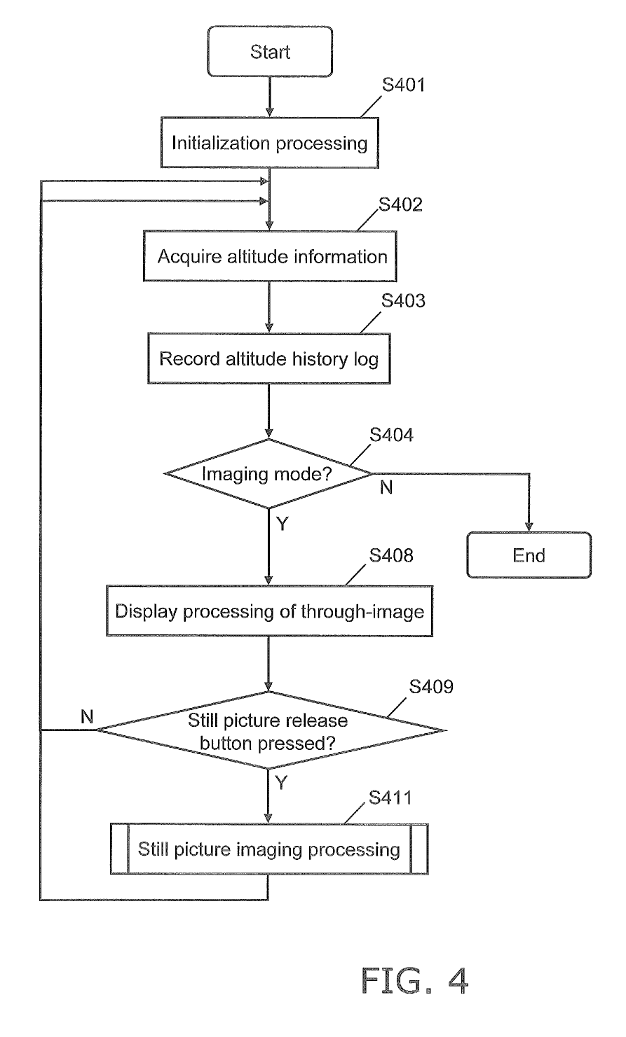

Imaging control of the digital camera 100 will be described. The digital camera 100 performs processing to provide captured image data with information related to the imaging time and the altitude at the imaging site, and processing to record this information. FIG. 4 is a flowchart of imaging control when the digital camera 100 is in imaging mode. The digital camera 100 can capture both moving pictures and still pictures in imaging mode. The capture of still pictures will be described here.

When the digital camera 100 has been put in imaging mode by operation of the mode switch 207 by the user, the controller 130 performs the initialization processing necessary for still picture recording (S401). In this initialization processing, not only the initialization processing necessary for recording, but actuation processing of the altimeter module 125 is also performed at the same time. Once initialization is complete, the altimeter module 125 periodically performs acquisition of altitude values in the background, and notification of altitude value acquisition is sent to the altitude recorder 133.

Upon receiving this notification, the altitude recorder 133 stores the acquired altitude values and an altitude history log ID corresponding to the altitude history log file currently being recorded, in the buffer memory 124. Specifically, the altitude recorder 133 stand ready to record the acquired altitude values and the altitude history log ID to the file produced when the image data is recorded (S402). The altitude recorder 133 also records as an altitude history log the altitude values acquired in step S402 every 15 minutes. More specifically, an altitude history log is added every 15 minutes to the altitude history log file of the memory card 140 (S403). Nothing is done in step S403 except when data is recorded every 15 minutes.

The altitude recorder 133 acquires altitude values at intervals shorter than 15 minutes (such as every second), but records altitude values only every 15 minutes to the altitude history log file. The altitude recorder 133 produces an altitude history log ID and records it to the altitude history log file when a new altitude history log file is produced. The altitude history log file can be uniquely specified by recording an altitude history log ID in the altitude history log file.

In this disclosure, the altitude history log file was written to every 15 minutes, but as long as recording is performed at regular intervals, the time period may be changed. Also, all of the acquired altitude values may be recorded to the altitude history log file. The altitude values and altitude history log ID are examples of altitude information.

The controller 130 repeatedly performs user input confirmation processing and display processing. Input confirmation processing and display processing include confirmation of the state of the mode switch 207 (S404), display of a through-image (S408), and monitoring of whether or not the still picture release button 201 has been pressed (S409). In step S404, the processing for imaging mode is ended if the mode switch 207 is not set to imaging mode.

The controller 130 performs processing to display a through-image according to the current setting values for display (S408). In this processing to display a through-image, the latest altitude value acquired by the altitude recorder 133 may be displayed.

In step S409, if the controller 130 detects that the still picture release button 201 has been pressed, still picture imaging processing is performed (S411). In step S409, if the controller 130 does not detect the pressing of the still picture release button 201, the controller 130 repeatedly executes the processing from step S402. When the still picture imaging processing of step S411 is ended, the controller 130 repeatedly executes the processing from step S402.

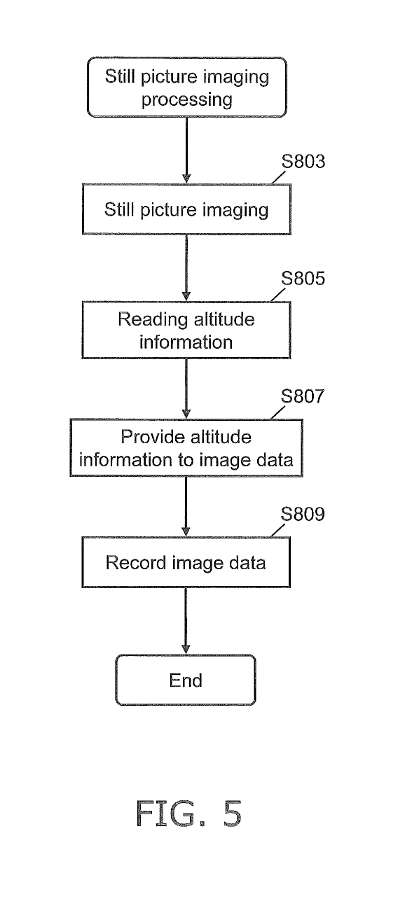

FIG. 5 is a flowchart of the flow of processing to capture a still picture. If the controller 130 detects that the still picture release button 201 has been pressed by the user, then a still picture produced by the image processor 122 is temporarily stored in the buffer memory 124 as image data on the basis of the image data produced by the CCD image sensor 120, at the point when the still picture release button 201 was pressed (S803). Next, the controller 130 reads the altitude value and altitude history log ID stored in the buffer memory 124 as altitude information about the site where the image was captured (S805). Finally, the controller 130 provides the image data with the altitude information acquired in step S805 (altitude value and altitude history log ID) (S807), records the result to the memory card 140 or another such recording medium (S809), and ends imaging processing.

### 2-2. Reproduction Operation of Digital Camera

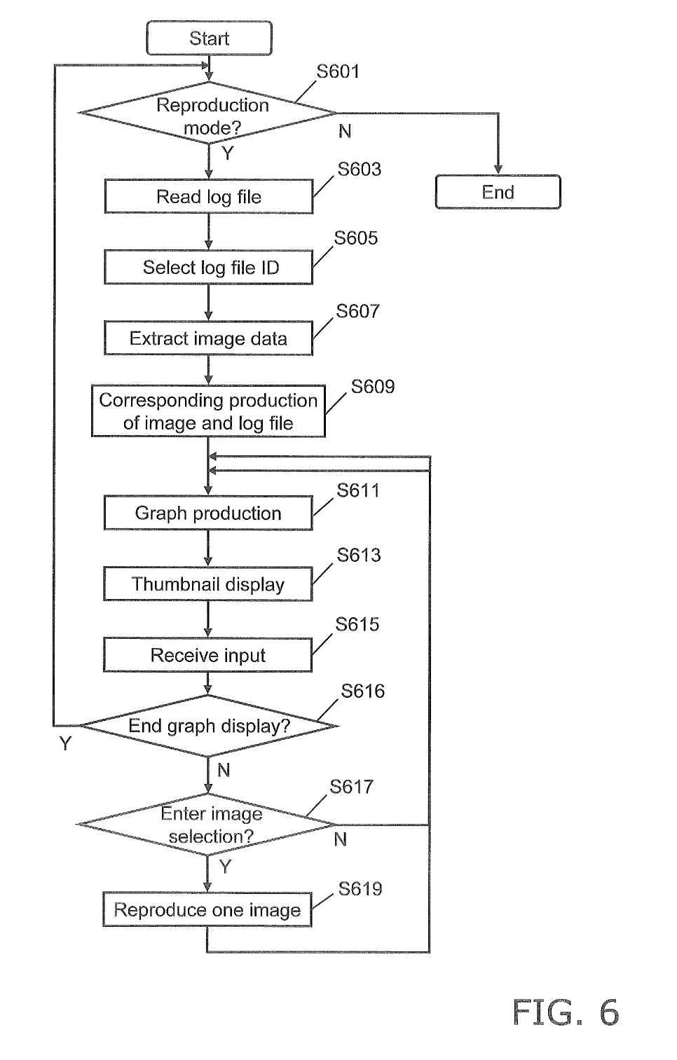

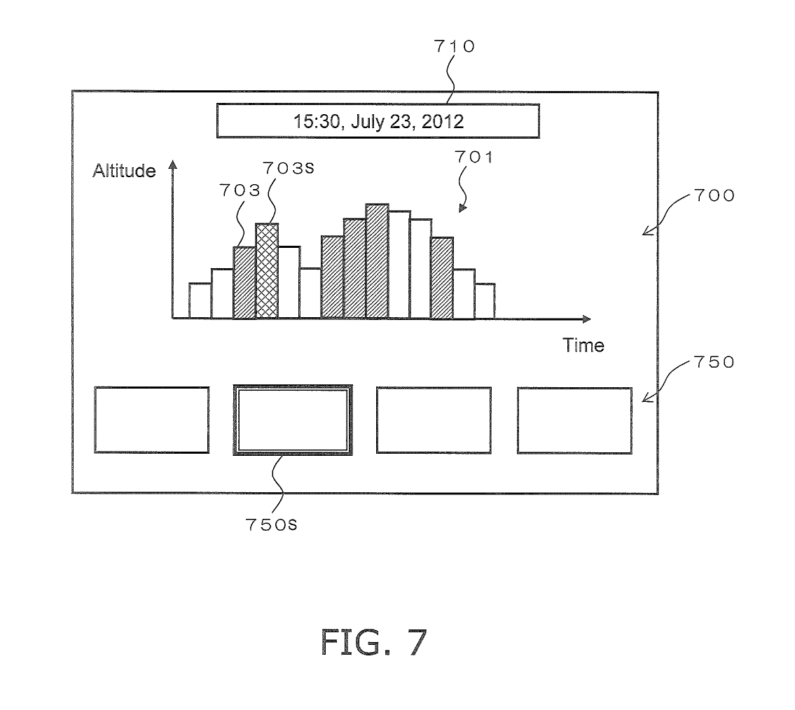

The reproduction operation of the digital camera 100 will be described. In reproduction mode, the digital camera 100 displays on the liquid crystal monitor 123 an altitude history graph produced from the altitude history log file recorded in step S403. The digital camera 100 also reads the image data recorded in step S809, and notifies the liquid crystal monitor 123 of information related to the times on the altitude history graph at which the various image data was captured. FIG. 6 is a flowchart of reproduction control during reproduction mode of the digital camera 100, and FIG. 7 shows an example of when thumbnails of the image data and the altitude history graph are displayed on the liquid crystal monitor 123.

The controller 130 confirms the state of the mode switch 207 (S601), and repeatedly performs user input confirmation processing and display processing. Input confirmation processing and display processing include selection of the altitude history log ID (S605), graph production (S611), thumbnail display (S613), and reproduction of one image (S619). In step S601, the processing of the reproduction mode is ended if the mode switch 207 is not set to reproduction mode (No in S601).

First, the controller 130 acquires all the altitude history logs recorded to the memory card 140 in order to decide on the altitude history log to be displayed (S603). Then, the controller 130 displays on the liquid crystal monitor 123 a list of the altitude history logs acquired in step S603. If the user has selected the desired altitude history log, the controller 130 recognizes this altitude history log (S605). For example, information indicating the start and end times when the altitude history log was recorded (not shown) is displayed on the liquid crystal monitor 123, which makes it easier for the user to select the desired altitude history log.

The controller 130 recognizes the altitude history log ID of the selected altitude history log by reading from the altitude history log file. The controller 130 then performs processing to extract only the image data captured during the recording of the altitude history log corresponding to this altitude history log ID. More specifically, the controller 130 extracts all of the image data in the memory card 140, and compares the altitude history log IDs recorded to the various image data with the altitude history log ID for the altitude history log designated by the user. The controller 130 extracts as the image data to be displayed only the image data with the matching altitude history log ID (S607).

The controller 130 sends the history manager 132 the image data extracted in step S607 and the altitude history log to be displayed. The history manager 132 refers to the times the various image data was captured, and produces data indicating the correlation between the image data and the altitude history log. When the history manager 132 produces data indicating the correlation between the image data and the altitude history log, processing is returned to the controller 130 (S609).

The “data indicating the correlation between the image data and the altitude history log” here is data indicating in which 15-minute period in the altitude history log the sent image data is included. More specifically, “data indicating the correlation” is data such as the following. When the altitude history log is recorded from 17:00 until 20:30, ten altitude values recorded every 15 minutes are recorded to the altitude history log along with the acquisition times. If we assume that one photograph was taken at 17:23, and one was taken at 20:03, the first photograph is included in the 17:15 altitude history log recorded just prior to 17:23. The 17:23 is the time at which the image was captured. The second photograph is included in the 20:00 altitude history log, just as with the first photograph. Specifically, the altitude history log closest to the time indicated by time information for the photograph (image data) is searched for on the basis of this time information, and this photograph is included in that altitude history log.

The controller 130 sends the graph producer 131 data indicating the correlation obtained in step S609. The graph producer 131 produces data for the graph 700 shown in FIG. 7 on the basis of the altitude history log to be displayed, and displays this data for the graph 700 as a graph on the liquid crystal monitor 123 (S611). The vertical axis of the graph 700 is the altitude value, and the horizontal axis is time. In this graph 700, data indicated by the altitude history log to be displayed, that is, an altitude history 701, is plotted as a bar graph.

In a graph of the altitude history 701, the colors of a bar graph in which image data is present are set to be displayed as a different color (such as black) from the color of a bar graph in which no image data is present. This allows the user to ascertain the altitude position at which the image data was captured in the graph of the altitude history 701. For example, when the user is mountain climbing, etc., the change in altitude during mountain climbing and image data captured along the way can be interpreted in relation to each other.

The controller 130 then displays the image data extracted in step S607 as thumbnails 750 (S613). For example, a thumbnail 750S out of these thumbnails 750 shows image data corresponding to the currently selected bar graph in the graph 700 (the bar graph indicating an altitude position 703S). The thumbnails 750 are the thumbnail 750S for the currently selected image data, and thumbnails of image data captured before and after this one. In the altitude history 701, the bar indicating the altitude position 703S corresponding to the time at which the currently selected image data was captured is displayed in a different color (such as yellow) from that of the bars indicating other positions. Also, a time 710 associated to the image data of this thumbnail 750S is displayed. “Time” here includes the date.

That is, image data captured at a time and altitude corresponding to the bar graph of the altitude position 703S is displayed as the thumbnail 750S. Also, the time corresponding to the thumbnail 750S (including the date) is displayed as time information for specifying the thumbnail 750S. Thumbnails of image data may be produced by reducing the image data to a specific size when the image data is recorded.

After the screen shown in FIG. 7 has been displayed on the liquid crystal monitor 123, the controller 130 enters a state of waiting for the receipt of a user input (S615). When the user has executed an input operation, the controller 130 performs processing to switch the screen in FIG. 7 according to the input to the manipulation component 150 by the user.

When the user performs an operation to end the graph display (S616), the controller 130 performs the processing from step S601 again. When the user performs an “enter” operation on the selected thumbnail 750S (S617), the controller 130 performs one-image reproduction processing to display the image data corresponding to the selected thumbnail 750S on the full screen of the liquid crystal monitor 123 (S619). In one-image reproduction, when the controller 130 recognizes a user command to end display, the controller 130 ends the one-image reproduction and performs the processing from step S611 again. If the user performs some other operation, the controller 130 performs the corresponding processing and then performs the processing from step S611 again.

This “other operation” includes an operation to move the thumbnail 750S (the one selected from among the thumbnails 750) to the next thumbnail or the previous thumbnail. When the selected thumbnail 750S is changed, an altitude position 703S in the altitude history 701 is additionally changed according to the newly selected thumbnail, and the display is updated. In FIG. 7, the user can perform not only an operation to change the selected thumbnail 750S, but also an operation to change the altitude position 703S in the altitude history 701. More specifically, this is an operation to select another bar graph of the altitude position 703 (move to the bar graph of another altitude position 703). The selected thumbnail 750S is also changed according to this operation. Here, a single altitude position corresponds to a time of 15 minutes in this embodiment. Therefore, a plurality of sets of image data corresponds to a single altitude position. When a plurality of sets of image data correspond to a single altitude position, the thumbnail corresponding to one of these plurality of sets of image data (such as the image data with the earliest time stamp) becomes the newly selected thumbnail 750S. If the user wishes to view image data captured at the peak in mountain climbing, for example, this operation eliminates the need to search for the desired image data by scrolling through the image data of the thumbnails 750 one at a time. Specifically, it is possible to display the image data captured at the target altitude position in the thumbnails 750 in fewer operational steps by moving the positions where the image data was captured on the altitude history 701.

### 3. Conclusion

(1) The digital camera 100 in this embodiment comprises the CCD image sensor 120 and the controller 130. The CCD image sensor 120 captures a subject image and outputs image data. The controller 130 records the time at which the CCD image sensor 120 produced the image data (a first time) so that it is associated with the image data. The controller 130 also periodically acquires an altitude value (information related to altitude). The controller 130 then associates the time at which the altitude value was acquired with an altitude value. The controller 130 then records the changes in altitude value as an altitude history log. The altitude value changes as the times at which the altitude values were acquired elapse. The controller 130 then performs control to display the recorded altitude history log and information indicating the time at which the image data was produced.

With this configuration, the changes in altitude can be recorded as an altitude history log at intervals including the time at which the image data was captured. During reproduction, the altitude history can be displayed as a graph, and the time at which the image data was captured can be shown in the graph. At the same time, thumbnails of the image data are displayed, and when the user designates a capture time in the graph (a bar graph), the thumbnail for the image data corresponding to that capture time can be distinguished from the others. Conversely, when the user designates a thumbnail, the corresponding capture time in the graph (a bar graph) can be shown differentiated from the others. Thus, this configuration makes the digital camera more convenient to use.

(2) The controller 130 displays an altitude history log as a graph indicating the change in altitude as the times at which altitude values were acquired elapse. The controller 130 also displays the places where the image data is present in the graph so as to be differentiated from the others. This allows the user to easily see the altitude at which an image was captured.

(3) The digital camera 100 further comprises the manipulation component 150. The controller 130 acquires altitude values at specific time intervals, such as every 15 minutes. When the user selects a certain altitude value, such as a certain bar graph, the controller 130 displays as a thumbnail image the image data captured in a specific time interval (within 15 minutes) using the time of the selected altitude value (bar graph) as a reference. This allows the user to easily ascertain the correlation between altitude and images.

(4) The controller 130 displays the altitude value selected by the user so as to differentiate it from the other altitude values. The controller 130 also displays a thumbnail image corresponding to the altitude value selected by the user so as to differentiate it from the other thumbnail images. This allows the user to more reliably ascertain the altitude value the user has selected and the images captured at that altitude.

(5) The controller 130 produces an altitude history log ID (identification data) for identifying a plurality of altitude history logs. The controller 130 then provides altitude history log ID's to the altitude history logs. The controller 130 displays the selected altitude history log on the basis of the altitude history log ID when one of the plurality of altitude history logs has been selected. Thus, the altitude history log can be uniquely specified by recording an altitude history log ID to the altitude history logs.

### Other Embodiments

This technology is not limited to the above embodiment, and various embodiments are possible. Other embodiments of this technology will be discussed below.

(A) In the above embodiment, the thumbnails displayed along with a graph of altitude history were thumbnails of the selected image data and thumbnails of image data captured at times before and after this. However, the display of thumbnails may be as follows. The displayed thumbnails may be only thumbnails of image data included in the selected altitude position.

(B) In the above embodiment, the changes in altitude value acquired between the start and end of log acquisition were produced as a single altitude history log. However, the following may be done instead.

Specifically, the configuration may be such that when the reference time on a built-in clock of the digital camera 100 is changed by the user, the altitude history log file is divided into before and after this time. When an altitude history log continues to be recorded to a single file when the reference time has changed, the time will be discontinuous before and after the time change. Also, when a change is made to return the current time, there is the risk that the same time will be present a plurality of times in a single altitude history log file. If this happens, there will not be a unique correlation between the altitude history log file and the time at which image data was captured.

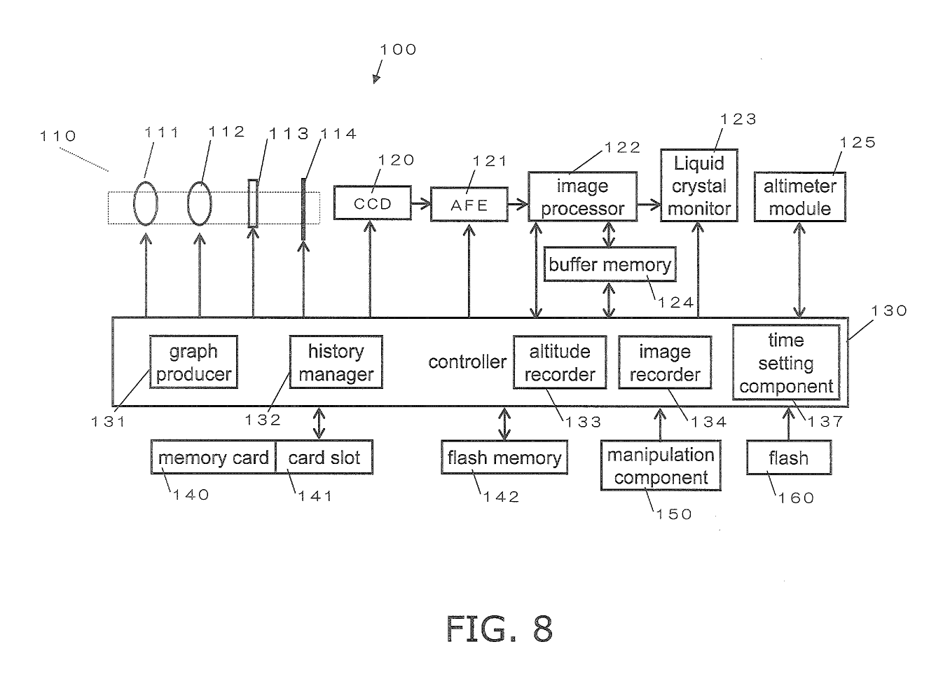

With the configuration of the above embodiment, as shown in FIG. 8, the controller 130 further comprises a time setting component 137, which solves this problem. The time setting component 137 sets the reference time of the built-in clock of the digital camera 100. The controller 130 produces a new altitude history log ID when the reference time changes, and provides the new altitude history log ID to the altitude history log whose reference time has changed.

Consequently, when the user changes the internal time of the digital camera 100, such as when the user changes the time of the digital camera 100 to match the time differences in overseas travel, etc., time discontinuity, redundancy, and so forth can be prevented. Specifically, the correlation between image data and the altitude history log can be uniquely determined.

(C) In the above embodiment, an example was given in which the altitude history log ID was used as identification data for differentiating altitude history information. Instead, an altitude history log ID and a device recognition ID for differentiating among devices may be used as identification data.

In this case, the controller 130 produces a new altitude history log ID when the device recognition ID is different, and provides a new altitude history log ID and device recognition ID as new identification data to the altitude history information. Consequently, even if image data produced by another digital camera 100 is incorporated into this digital camera 100, an altitude history log made up of image data of the other digital camera 100 can be differentiated from an altitude history log made up of image data of this digital camera 100.

(D) In the above embodiment, an example was described in which the captured image data was a still picture, but the captured image data may be a moving picture instead. In this case, altitude values that are recorded together may be altitude values corresponding to the site where capture of the moving picture started, or may be altitude values indicating the site where imaging ended, or altitude values may be acquired at regular intervals during imaging and all of these included, or just a plurality of these may be included.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of the imaging device. Accordingly, these terms, as utilized to describe the present technology should be interpreted relative to the imaging device.

The term “configured” as used herein to describe a component, section, or part of a device implies the existence of other unclaimed or unmentioned components, sections, members or parts of the device to carry out a desired function.

The terms of degree such as “substantially”, “about” and “approximately” as used herein mean a reasonable amount of deviation of the modified term such that the end result is not significantly changed.

While only selected embodiments have been chosen to illustrate the present technology, it will be apparent to those skilled in the art from this disclosure that various changes and modifications can be made herein without departing from the scope of the technology as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further technologies by the applicant, including the structural and/or functional concepts embodied by such feature(s). Thus, the foregoing descriptions of the embodiments according to the present technologies are provided for illustration only, and not for the purpose of limiting the technology as defined by the appended claims and their equivalents.

### INDUSTRIAL APPLICABILITY

The present technology makes it possible to provide an imaging device that is more convenient to use, and can therefore also be applied to digital still cameras, movie cameras, portable telephones, smart phones, mobile PC's, and so forth.

What is claimed is:

1. An imaging device, comprising:
an imaging component configured to capture an image of a subject, produce image data at a first time and output the image data;
an image recorder configured to associate the first time with the image data and record the first time associated with the image data;
an altitude recorder configured to periodically acquire information related to an altitude, associate a second time with the information related to the altitude, and record changes in the information related to altitude corresponding to an elapse of the second time, as altitude history information, the information related to altitude acquired at the second time, and
a display controller configured to display the altitude history information recorded by the altitude recorder, and information indicating the first time.

2. The imaging device according to claim 1, wherein:
the display controller displays the altitude history information as a graph indicating the changes in altitude corresponding to the elapse of the second time, and displays a place corresponding to the image data in the graph so that the place is differentiated from other places.

3. The imaging device according to claim 1, further comprising:
a selector configured to select the information related to altitude, the information related to altitude is included in the altitude history information, wherein:
the altitude recorder is configured to acquire the information related to the altitude at specific time intervals, and
if the selector selects the information related to altitude, the display controller displays the image data captured at the specific time intervals as a thumbnail image, based on the second time of the selected information related to the altitude.

4. The imaging device according to claim 3, wherein:
the display controller displays the information related to the altitude selected by the selector such that it is differentiated from other information related to altitude, and displays the thumbnail image corresponding to the information related to the altitude selected by the selector such that the thumbnail image is differentiated from other thumbnail images.

5. The imaging device according to claim 1, wherein:
the altitude recorder produces identification data for differentiating among a plurality of sets of the altitude history information, and adds the identification data to the altitude history information, and
if any one of the plurality of sets of the altitude history information is selected, the display controller displays the selected altitude history information based on the identification data.

6. The imaging device according to claim 5, further comprising:
a time setting component configured to set a reference time on a clock built into the imaging device, wherein:
if the reference time changes, the altitude recorder produces new identification data and adds the new identification data to the altitude history information recorded after the reference time has changed.

7. The imaging device according to claim 5, wherein:
the identification data includes information identification data for differentiating altitude history information, and device identification data for differentiating devices, and
if the device identification data is different from the other device identification data, the altitude recorder produces new information identification data, and adds the new information identification data and the device identification data to the altitude history information as new identification data.

8. An image reproduction device, comprising:
an image acquisition component configured to acquire image data associated to time;
an altitude history information acquisition component configured to acquire altitude history information, the altitude history information indicating changes in information related to an altitude corresponding to an elapse of time; and
a display controller configured to display the altitude history information and information indicating the time associated to the image data.

9. The image reproduction device according to claim 8, wherein:
the display controller displays the altitude history information as a graph indicating the changes in altitude corresponding to the elapse of time, and displays a place corresponding to the image data in the graph so that the place is differentiated from other places.

10. An imaging device comprising:
an imaging unit configured to produce image data of a subject captured at a first time and output the image data;
an image recorder configured to receive the image data output by the imaging unit, associate the image data with the first time at which the subject was captured, and record the image data in association with the first time;
an altitude recorder configured to periodically acquire information related to an altitude of the imaging device and record a plurality of altitude history logs each containing the acquired altitude information over a predetermined time period; and
a display controller configured to display the image data of the subject captured at the first time and display data representative of one of the plurality of altitude history logs having the predetermined time period closet to the first time.

11. The imaging device according to claim 10, wherein the display controller displays the data representative of one the plurality of altitude history logs in the form of a bar graph and displays the image data of the subject as a thumbnail image.
